(19) United States
(12) Patent Application Publication
(10) Pub. No.: US 2016/0100529 A1
(43) Pub. Date: Apr. 14, 2016

(54) MOUNTING SYSTEM FOR HORTICULTURAL LIGHTING

(71) Applicant: Once Innovations, Inc., Plymouth, MN (US)

(72) Inventor: Zdenko Grajcar, Orono, MN (US)

(21) Appl. No.: 14/882,958

(22) Filed: Oct. 14, 2015

Related U.S. Application Data
(60) Provisional application No. 62/063,701, filed on Oct. 14, 2014.

(51) Int. Cl. A01G 7/04; A01G 9/14; F21V 21/096; A01G 9/20

(52) U.S. Cl. CPC A01G 7/045; A01G 9/20; A01G 9/14; F21V 21/096; F21Y 2101/02

(57) ABSTRACT

An incubation chamber having a plurality of shelves for receiving plants within a horticultural growing facility. Low profile lighting devices are provided that have a body that is of limited height and utilizes at least one magnet in order to magnetically secure the low profile lighting device to a shelf to direct light onto the incubated plants.

### CLAIM OF PRIORITY

This patent application is based upon and claims the benefit of priority of U.S. Provisional Patent Application Ser. No. 62/063,701, filed Oct. 14, 2014, entitled “Mounting System for Horticultural Lighting” which is hereby incorporated by reference herein in its entirety.

### BACKGROUND

Plants are predominantly grown outdoors with sunlight providing the main source of light for each plant. Still, as society continues to advance and urban sprawl continues, less and less farmland exists, not just within the U.S. but world-wide. In general the amount of family farms and farmland in general continues to shrink. The family farm is thus slowly being phased out by large corporate farming.

Corporate farms strive on efficiency and getting the most out of their land and crops. They pack as much crop as possible onto their land and then will use chemically engineered seed, fertilizer and pesticide to give them the best chance of producing a bountiful crop. Still, even the corporate farmers are reliant on weather and prone to natural disasters such as fire or flooding.

Over the years, indoor greenhouses have been used to house and grow plants. Often greenhouses would have a glass ceiling, still depending on sunlight to provide photosynthesis. Then greenhouses began using incandescent or artificial lighting indoors. Hydroponic systems also have grown in more prevalence over the last decade as individuals and companies are beginning to see value in moving plant growing activities indoors, away from the unpredictable weather and where planting can occur all year long.

As time has progressed, indoor horticultural growing systems have progressed as companies have desired greater efficiencies in growing their plants. Companies have begun to understand the importance of lighting on the plant and providing wavelengths of light that the sun provides and incandescent lighting cannot. Systems also have become more compact as companies have begun to understand that when artificial lighting is being brought to the plants, the plants can increase numbers not just by growing more plants in a side by side relation, but also growing plants upwardly, stacked on shelved units in larger walk in incubators.

Lighting for these incubators is typically run from the ceiling and directed at the individual plants. However, efficiency would improve if lighting could be mounted efficiently in close proximity to the plants. Thus an improved lighting and light mounting system is desirable.

### OVERVIEW

This application relates to horticultural lighting. More specifically to a mounting system for horticultural lighting. An object of the present invention is to provide a lighting system that efficiently provides light for plants in an indoor environment. Yet another object of the present invention is to provide a lighting system designed to facilitate installation.

An example embodiment includes an incubation chamber that has a plurality shelves stacked in parallel spaced relation on a support structure. The shelves receive a plurality of plants for incubation. Low profile lighting devices are secured to the underside of the shelves adjacent the plants to provide lighting to the plants. The lighting devices include an elongated channel for receiving a substrate and a groove surrounding a recessed surface. The groove receives a plurality of magnets therein to magnetically secure to a shelf while providing a low profile. These and other objects, features and advantages will become apparent from the specification and claims.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a side view of a growing facility with an incubation chamber;

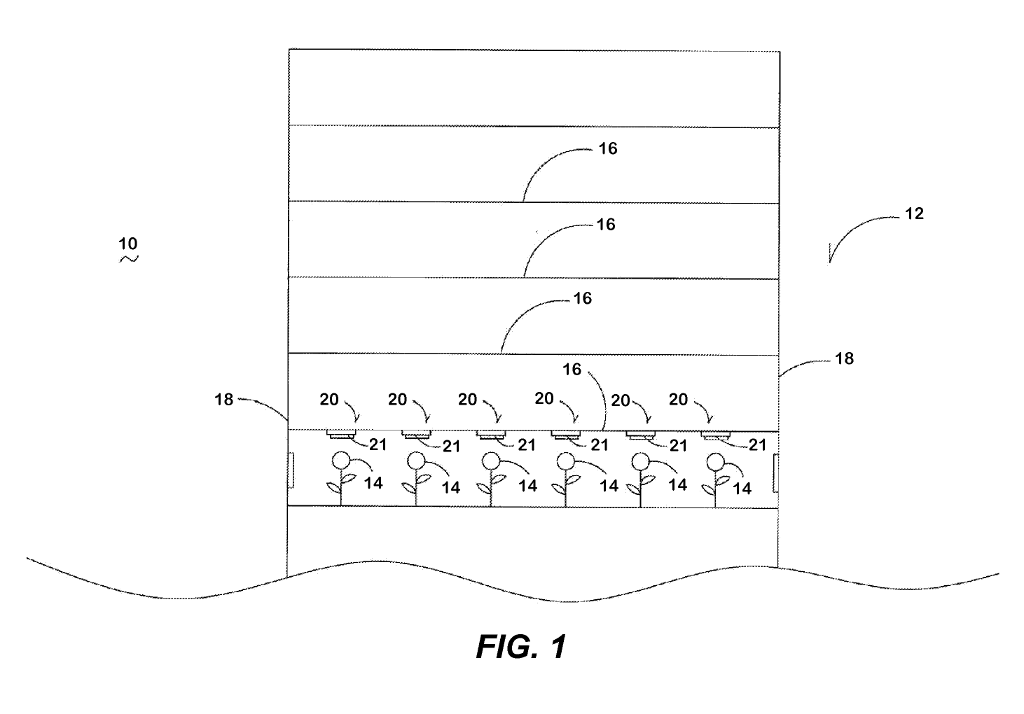

FIG. 2 is a side view of a horticultural lighting device;

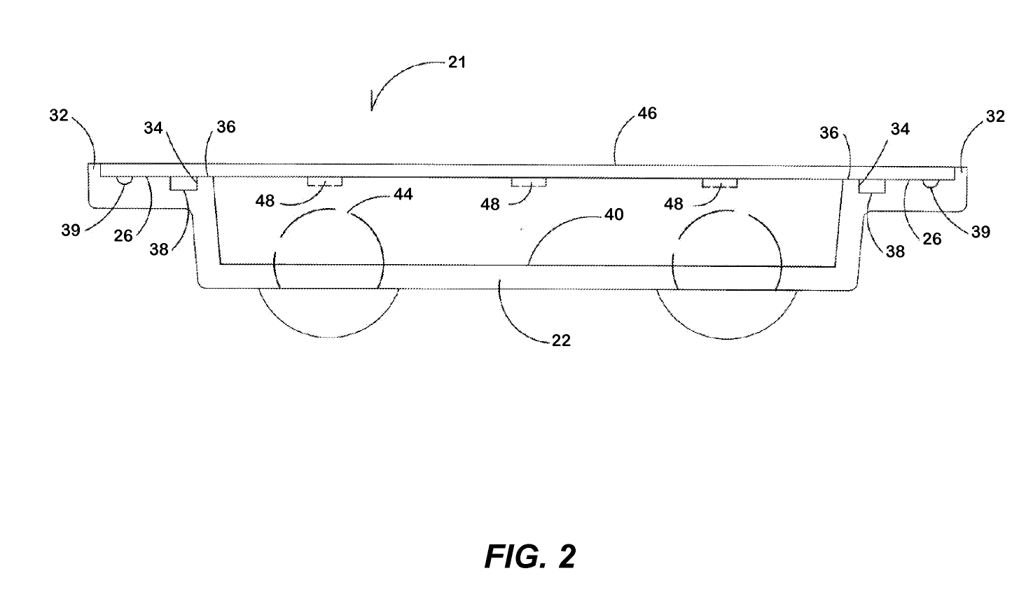

FIG. 3 is a perspective top view of a horticultural lighting device;

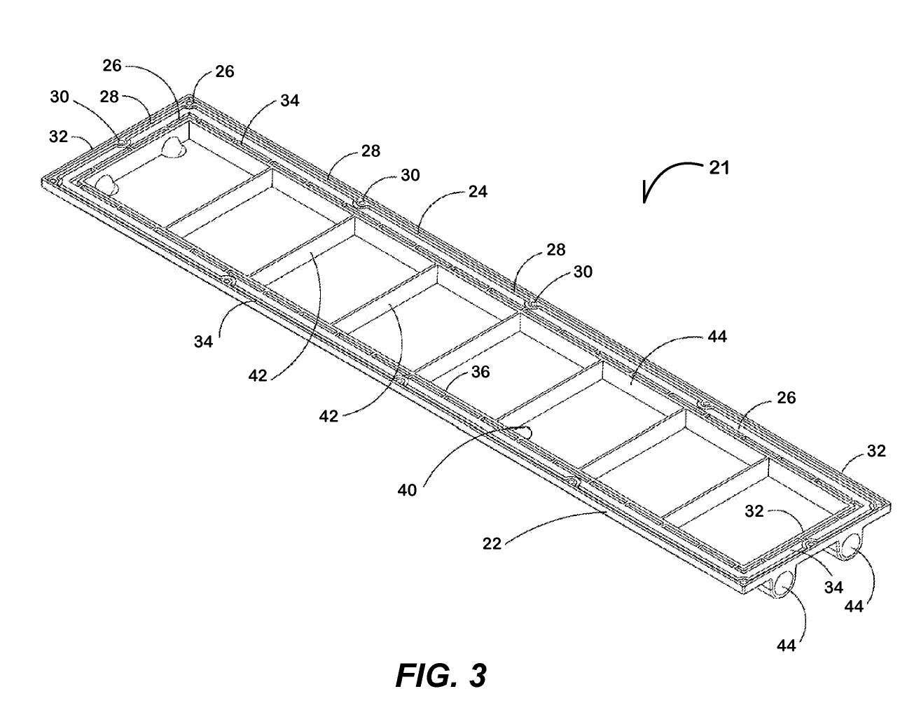

FIG. 4 is a perspective view of the lens side of a horticultural lighting device; and

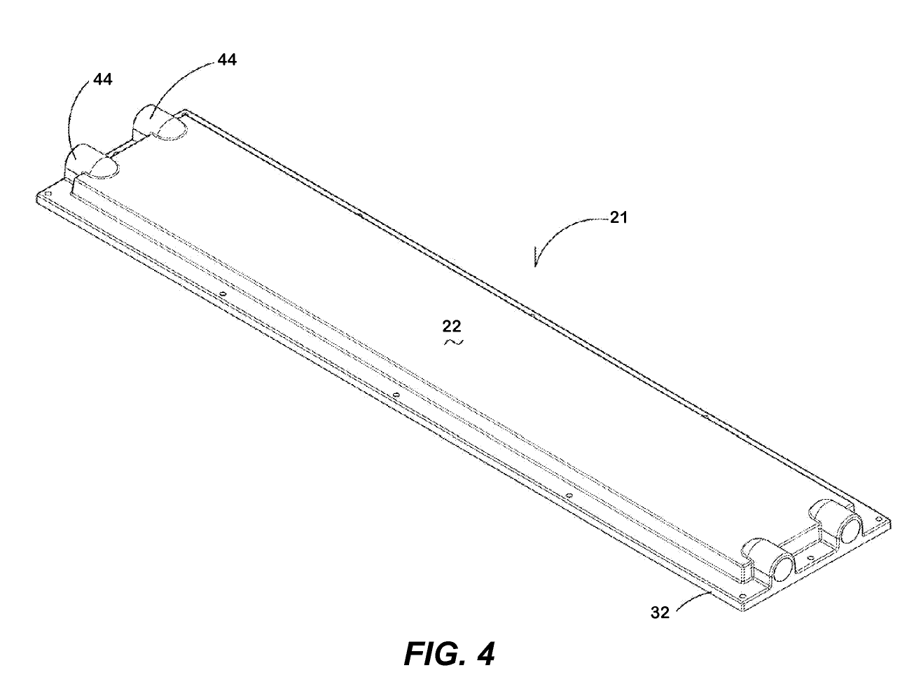

FIG. 5 is a schematic diagram of a circuit on a substrate of a horticultural lighting device.

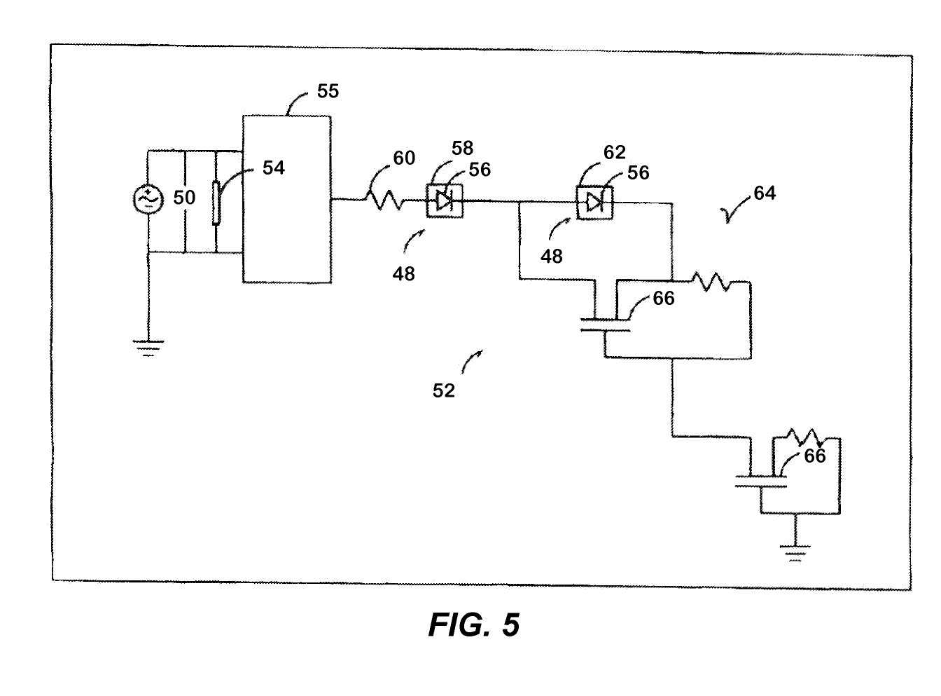

### DETAILED DESCRIPTION

The figures show a horticultural growing facility 10 having a plurality of incubation chambers 12 where plants 14 are grown. The plants 14 can be of any type, whether leafy, growing from a stalk, growing underground or the like and includes, but is not limited to corn, tomatoes, lettuce, swiss chard, alfalfa, broccoli, spinach, potatoes, strawberries, cannabis, flowers and the like. Each plant 14 is placed either on or in a shelf member 16 where a plurality of shelf members 16 are secured to a support structure 18 in spaced relation to the floor and to one another. In some embodiments only a single shelf member 16 is provided and in other embodiments multiple shelf members 16 are provided. In general each shelf is constructed of a metallic material such as steal or other metallic material.

Lighting devices 20 are secured to individual shelf members 16 or to the support structure 18. Each lighting device 20 has a lens element 21 with an elongated body 22 having a low profile that in one embodiment is less than 20 millimeters in height. The elongated body 22 has a top side 24 with a recessed surface 26 surrounded by a continuous ledge 28 having a plurality of eyelets 30 therein for receiving a fastener. The continuous ledge 28 terminates in an outer edge 32.

A groove 34 extends around the perimeter of the body 22 adjacent the recessed surface 26, terminating in the recessed surface 26 on one side and an inner edge 36 on the other. In one embodiment, disposed within the groove 34 is at least one magnet 38 that in one embodiment is a plurality of magnets 38. Preferably the magnets 38 are rare earth magnets including but not limited to neodymium and samarium-cobalt magnets. An auxiliary groove 39 is disposed through the recessed surface 26 in parallel spaced relation to the groove 34 for receiving an adhesive such as glue.

A channel 40 is centrally located and disposed within the body 22 extending the length of the body 22 and having the inner edge 36 as a perimeter such that the recessed surface 26 forms a flange extending from the channel 40. A plurality of rib members 42 run across the channel in parallel spaced relation and extend from one inner edge 36 to another 36 to provide additional structural support to the lens element 21. Electrical portals 44 that are in parallel spaced relation to one another are disposed through either end of the lens element 21 to provide a location for electrical wiring.

A substrate 46 is disposed within the body 22 and engages the recessed surface 26 and is of height to slide under, or into the continuous ledge 28 to be held in place by the continuous ledge 28 such that glue or other adhesive is placed in the auxiliary groove 39 and fasteners are disposed through the eyelets 30 of the continuous ledge to secure the substrate 46 to the body 22. In a preferred embodiment the substrate 46 is a printed circuit board (PCB). In another embodiment the magnets 38 are adhered directly to the substrate 46. Alternatively the magnets 38 are embedded into the body 22 or substrate 46. In particular the magnets 38 are positioned to be either flush with the recessed surface 26 of the elongated body 22 or in close proximity to the top plane of the body 22 such that that the magnets 38 firmly attach the body 22 to a shelf member 16 or support structure 18 as needed. The magnets 38 thus provide a manner to secure the lighting device 20 directly to a shelf member 16 or to the support structure 18 that minimizes the height of the securing structure to ensure the lighting device 20 remains low profile allowing an optimum amount of space for plant 14 growth.

In the embodiment where the substrate 46 is flush with the top of the outer edge 32 when the lens element 21 is secured to a shelf member 16 or support structure 18 the substrate engages the shelf member 16 or support structure 18. As a result, heat is conveyed directly from the substrate 46 into the shelf member 16 or support structure 18. In addition, the substrate 46 forms a water tight seal with the lens element 21 to prevent the ingress of water into the channel 40 and onto the circuitry on the substrate 46. A sealing element can optionally be used to additionally prevent the ingress of water and keep the recess water free and the lighting device 20 water resistant.

A plurality of lighting elements 48, that in one embodiment are lighting emitting diodes are secured to the substrate 46 as is known in the art. Each lighting element 48 causes the emission of ultraviolet light and near ultraviolet light (350-450 nm), blue wavelength (450-495 nm) light, green, yellow or orange light or red light (620-750 nm) or electromagnetic radiation. Specifically, lighting elements 48 have electromagnetic radiation/ultraviolet/blue wavelength lighting elements and red wavelength elements combined on the same substrate 46. Such ultraviolet, blue or red wavelength lighting elements 48 in one embodiment have light duration periods that are different. So, as an example only, a first blue wavelength lighting element 48 has a light duration period of three milliseconds (ms) while a red wavelength lighting element has a light duration of two seconds.

Alternatively the lighting elements 48 have the same duration only staggered. As an example of this embodiment, a first blue wavelength lighting element 48 has a duration or period of three ms of light and three ms of dark. A second red wavelength lighting element 48 is also provided on the tray that also has a duration or period of three ms of light and three ms of dark. In one embodiment the first and second lighting elements emit light at the same time or present an overlap. In another embodiment, the second red wavelength lighting element is dark during the three ms the first blue wavelength lighting element is producing light. Then when the second red wavelength lighting element is producing light for three ms the first blue lighting element in dark and not emitting light.

The lighting elements 48 are powered by an electrical power source 50 and further have a dimming device that causes the intensity of the light to be reduced to less than three lumens. Thus a constant low intensity wavelength light is emitted from the lighting device 20. The light can be of a narrow frequency or monochromatic to direct the exact wavelength of light desired. In addition, while described as low intensity, a higher intensity wavelength of light can be provided. Further, in the embodiment where LED elements are utilized because of the properties of LED lighting elements, the lights can be left on for long durations of time.

While the intensity of the light can be reduced to less than three lumens, the intensity of the light similarly can be increased to output 800 lumens, 1000 lumens or more. Similarly, while light duration can be for long periods of time such as days, weeks or months, the duration between light and dark periods can also be controlled to hours, minutes, seconds and even ml seconds.

The lighting elements 48 are dimmable and are constructed as is described in U.S. Pat. No. 8,643,308 to Grajcar and/or U.S. Pat. No. 8,531,136 to Grajcar, both of which are incorporated herein in their entirety. One such assembly as an example only has a pair of input terminals 50 that are adapted to receive a periodic excitation voltage such that the terminals 50 can receive AC current or a current of equal magnitude and opposite polarity, said current flowing in response to the excitation voltage to provide an AC input. The AC current is then conditioned by driving circuitry 52 that optionally includes an metal oxide varesistor (MOV) 54 and a rectifying device 55 that in a preferred embodiment is a bridge rectifier formed of a plurality of light emitting diodes (LEDs) 56.

The light emitting diodes (LEDs) 56 are arranged in a first network 58 where the first network 58 is arranged to conduct the current in response to the excitation voltage exceeding at least a forward threshold voltage associated with the first network 58. Optionally depending on the driving circuitry 52 a resistor 60 or multiple resistors can be used to condition the current before reaching the first network 58. The LEDs 56 of the first network 58 can be of any type or color. In one embodiment the LEDs 56 of the first network 58 are red LEDs that produce light having a wavelength of approximately 600-750 nanometers (nm). In another embodiment the first network of LEDs are blue LEDs that produce light having a wavelength of approximately 350-500 nm. Alternatively both red and blue LEDs can be provided together or other colored LEDs such as green may similarly be used without falling outside the scope of this disclosure.

A second network 62 having a plurality of LEDs 56 is additionally provided in series relationship with the first network 58. The LEDs 56 of the second network 62 can be of any type or color. In one embodiment the LEDs 56 of the second network 62 are red LEDs that produce light having a wavelength of approximately 600-750 nanometers (nm). In another embodiment the second network of LEDs are blue LEDs that produce light having a wavelength of approximately 350-500 nm. Alternatively both red and blue LEDs can be provided together or other colored LEDs such as green may similarly be used without falling outside the scope of this disclosure.

A bypass path 64 is provided in the lighting element 48 that is in series relationship with the first network 58 and in parallel relationship with the second network 62. Also within the bypass path 64 are elements that provide a controlled impedance, which can be, for example only a transistor 66 that in one embodiment is a depletion MOSFET. Additional transistors, resistors or the like can be used within the bypass path 64 all that condition current to provide the smooth and continuous transition from the bypass path 64 to the second network 62.

In operation when manufacturing the lighting device 20 the low profile elongated body 22 is formed with the at least one magnet 38 therein. The substrate 46 is placed into the recessed surface 26 of the elongated body 22 and adhered and secured thereto such that the substrate 46 forms the top surface of the lighting device 20. Then during installation the elongated body is secured directly to the underside of a shelf member 16 or a ceiling or other part of a support structure 18 by magnetically securing the elongated body 22 to the shelf member 16 or support structure 18. Wiring is then passed through the electrical portals 44 so that the lighting device 20 can be wired into an input for providing light to a plant 14 disposed within or on a shelf member 16. As the lighting device 20 operates the heat created by the electronic components on the substrate 46 is conveyed directly from the substrate to the shelf member 16 or support structure 18, or alternatively from the body 22 to the shelf member 16 or support structure 18 to optimize heat conveyance properties.

Thus provided is a lighting device 20 with a mounting structure that uses magnets 38 to present a low profile lighting device 20 that can be placed on shelf members 16 to provide maximum lighting for plants 14 within a facility 10 and optimum heat transfer properties. By using the magnets 38 to secure the elongated body 22 to the shelf member 16 or support member 18 a minimal amount of structure is provided allowing the elongated body to remain as low profile.

As a result of being low profile and water resistant the lighting devices 20 can also be placed adjacent the plants 14, thus decreasing the intensity required out of the lighting elements 48 to provide sufficient lighting for the plants 14. Specifically, the amount of lux received from lighting on a plant 14 is dependent on the distance a light source is from the plant 14, thus, by providing a lighting device adjacent the plant 14, the amount of lumen output required by the lighting device 20 is reduced, allowing for higher efficiencies and lower manufacturing costs. Specifically, if used in combination with shelf members 16 that have adjustable height to accommodate a growing plant 14, the required lumen output of the lighting device 20 is minimized, decreasing manufacturing costs and minimizing potential malfunctioning of the lighting device 20 as a result of over driving the circuitry. In converse, by placing the lighting device 20 adjacent the plant 14 the amount of photosynthetic energy provided to the plant 14 is increased compared to a lighting device 20 placed a greater distance from the plant 14.

In addition to allowing the lighting device 20 to be low profile, by using a mounting system using magnets, installation and replacement procedures are facilitated. In particular the lighting device 20 can be easily secured to and detached to a shelf member 16 or support structure 18 and similarly, if the substrate 46 has a malfunctioning electronic component, the substrate can easily be replaced without having to replace the entire lighting device 20. Thus, at the very least all of the stated objects have been accomplished.

What is claimed:

1. An incubation chamber for growing plants comprising:
a plurality of shelf members secured to a support structure;
at least one shelf member receiving at least one plant;
a low profile lighting device secured to a shelf member adjacent the at least one plant to direct light from the low profile lighting device onto the at least one plant.

2. The incubation chamber of claim 1 wherein the low profile lighting device has at least one magnet that secures the low profile lighting device to the shelf member.

3. The incubation chamber of claim 2 wherein the at least one magnet is disposed within a groove.

4. The incubation chamber of claim 2 wherein the at least one magnet is a samarium-cobalt magnet.

5. The incubation chamber of claim 2 wherein the low profile lighting device has a body that receives a substrate having a plurality of light emitting diode thereon.

6. The incubation chamber of claim 5 wherein the at least one magnet is embedded into the substrate.

7. The incubation chamber of claim 5 wherein the at least one magnet is adhered to the substrate.

8. The incubation chamber of claim 5 wherein the magnet secures the substrate against the shelf member.

9. The incubation chamber of claim 2 wherein at least one magnet is positioned flush with a recessed surface of a body of the low profile lighting device.
